(19) United States
(12) Patent Application Publication
(10) Pub. No.: US 2011/0229238 A1
(43) Pub. Date: Sep. 22, 2011

(54) Tape Cartridge

(75) Inventor: Akihiro Shintani, Nagano-ken (JP)

(73) Assignee: Seiko Epson Corporation, Tokyo (JP)

(21) Appl. No.: 13/040,800

(22) Filed: Mar. 4, 2011

(30) Foreign Application Priority Data
Mar. 18, 2010 (JP) 2010-062075
Mar. 18, 2010 (JP) 2010-062076

(51) Int. Cl. B41J 35/28

(52) U.S. Cl. 400/208

(57) ABSTRACT

A tape cartridge attached to an attachment unit of a tape printer includes: a cartridge case which has an upper case and a lower case, wherein the cartridge case includes a tape storing unit storing a printing tape on which printing is performed by using a thermal head provided on the tape printer, a ribbon storing unit storing an ink ribbon used for printing on the printing tape by using the thermal head, and an opening into which the thermal head is inserted, and an openable and closable shutter structure is provided on the opening.

### CROSS-REFERENCE TO RELATED APPLICATION

The entire disclosure of Japanese Patent Application No. 2010-062076, filed on Mar. 18, 2010, is expressly incorporated by reference herein.

### BACKGROUND

1. Technical Field

The present invention relates to a tape cartridge.

2. Related Art

A tape cartridge of a type disclosed in Japanese Utility Model Registration No. 3,041,381, for example, is known. This tape cartridge attached to an attachment unit of a tape printer includes a storage unit for storing a tape core around which a printing tape is wound as a target of printing by a printing head of the printer and a ribbon core around which an ink ribbon is wound, and further includes an opening into which the printing head is inserted.

According to the tape cartridge in the related art described above, there is a possibility that dust enters the inside of the tape cartridge through the opening into which the printing head is inserted. For avoiding this problem, the tape cartridge is packed for each during transportation such that entrance of dust can be prevented. However, after the package is opened by a user, the opening is constantly exposed to the outside, which allows dust to enter the inside of the tape cartridge. Thus, problems such as poor printing are caused by the dust adhering to the printing tape or the ink ribbon.

### SUMMARY

An advantage of some aspects of the invention is to provide a tape cartridge and a tape printer capable of preventing entrance of dust through an opening of the tape cartridge for avoiding poor printing.

### Application Example 1

According to this application example of the invention, there is provided a tape cartridge attached to an attachment unit of a tape printer including a cartridge case which has an upper case and a lower case. The cartridge case includes a tape storing unit storing a printing tape on which printing is performed by using a thermal head provided on the tape printer, a ribbon storing unit storing an ink ribbon used for printing on the printing tape by using the thermal head, and an opening into which the thermal head is inserted. An openable and closable shutter structure is provided on the opening.

According to this structure, the openable and closable shutter structure is provided on the opening into which the printing head is inserted. This structure prevents entrance of dust into the tape cartridge. Thus, poor printing caused by dust can be avoided.

### Application Example 2

This application example of the invention is directed to the tape cartridge of the above application example, wherein the shutter structure executes an opening and closing operation by sliding on case rails provided on the upper case and the lower case of the cartridge case.

According to this structure, the shutter structure slides on the case rails provided on the upper case and the lower case. Thus, the opening and closing operation is smoothly carried out, and entrance of dust through the opening is prevented. Accordingly, poor printing caused by dust can be avoided.

### Application Example 3

This application example of the invention is directed to the tape cartridge of the above application example, wherein the shutter structure further includes an open/close projection; and the shutter structure executes the opening and closing operation by moving the open/close projection.

According to this structure, the opening and closing operation is more smoothly conducted by moving the open/close projection such that entrance of dust through the opening can be prevented. Accordingly, poor printing caused by dust can be avoided.

### Application Example 4

This application example of the invention is directed to the tape cartridge of the above application example, wherein the opening and closing operation of the shutter structure opens the opening at least during printing and keeps closing the opening except for the time of printing.

According to this structure, the opening is opened at least only during printing. Thus, entrance of dust is further prevented. Accordingly, poor printing caused by dust can be avoided.

### Application Example 5

This application example of the invention is directed to the tape cartridge of the above application example, wherein the shutter structure executes the opening and closing operation in accordance with a head release mechanism included in the tape printer.

According to this structure, the shutter structure moves with the head release mechanism of the tape printer. Thus, the opening is securely opened at the time of printing, and is closed when the tape cartridge is removed from the tape printer without requiring operation by a user. Thus, entrance of dust is prevented even while the tape cartridge is being carried separately. Accordingly, poor printing caused by dust can be avoided.

### BRIEF DESCRIPTION OF THE DRAWINGS

The invention will be described with reference to the accompanying drawings, wherein like numbers reference like elements.

FIG. 1 illustrates the external appearance of a tape printer with its cover opened.

FIG. 2 illustrates a concept of a condition in which a shutter of a tape cartridge is closed in a first embodiment.

FIG. 3 illustrates a concept of a condition in which the shutter of the tape cartridge is opened in the first embodiment.

FIGS. 4A and 4B illustrate a concept of case rails provided on an upper case and a lower case.

FIGS. 5A and 5B illustrate a concept of an open/close cover and a head operation.

FIG. 6 illustrates a concept of a condition in which a shutter is opened in a second embodiment.

FIG. 7 illustrates a concept of a condition in which the shutter is closed in the second embodiment.

### DESCRIPTION OF EXEMPLARY EMBODIMENTS

A tape cartridge and a tape printer according to an embodiment of the invention are hereinafter described with reference to the accompanying drawings. The tape printer performs printing by using a printing unit while drawing a printing tape and an ink ribbon from an attached tape cartridge and delivering the printing tape and the ink ribbon in tension in synchronization with each other, and cuts a printed portion of the printing tape into a label (tape piece).

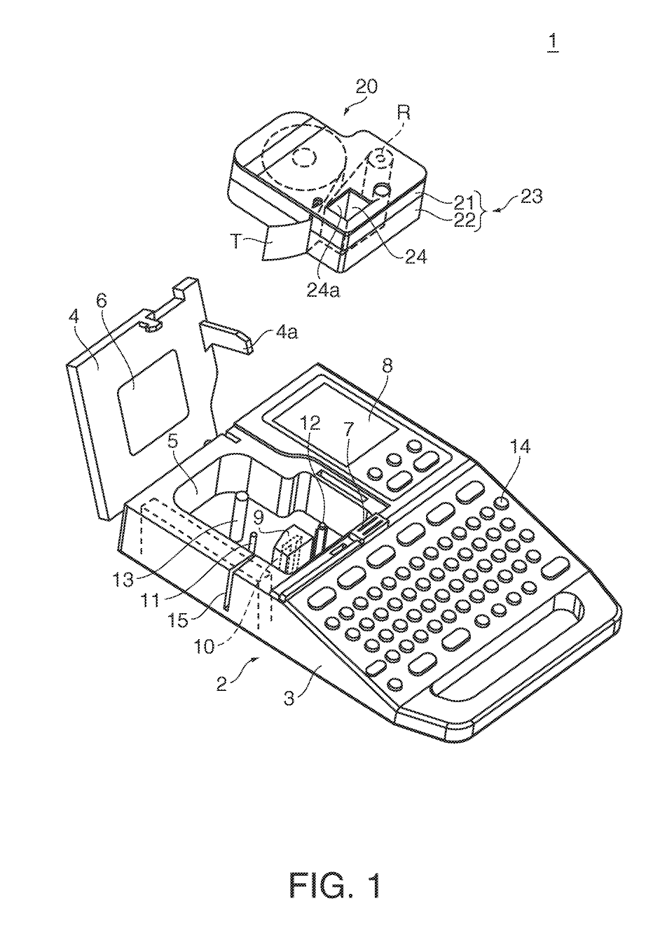

FIG. 1 is a perspective view illustrating the whole appearance of a tape printer 1 according to an embodiment of the invention. The tape printer 1 includes a device main body 2 which performs a printing process on a printing tape T, and a tape cartridge 20 which stores the printing tape T and an ink ribbon R and is attached to the device main body 2 in such a manner as to be freely attached to and detached from the device main body 2.

The device main body 2 of the tape printer 1 has a device case 3 constituting the external case, and a keyboard 14 disposed on the front half area of the upper surface of the device case 3 and containing various types of keys. An open/close cover 4 widely extends on the left rear half area of the upper surface of the device case 3. A cartridge attachment unit 5 to which the tape cartridge 20 is attached is formed inside the open/close cover 4. A check window 6 through which the attachment and non-attachment of the tape cartridge 20 is visually checked is provided on the upper surface of the open/close cover 4. A cover opening button 7 for opening the open/close cover 4 is equipped on the front side of the open/close cover 4. A display 8 for displaying input results inputted from the keyboard 14, printing images and the like is provided on the right rear half area of the upper surface of the device case 3.

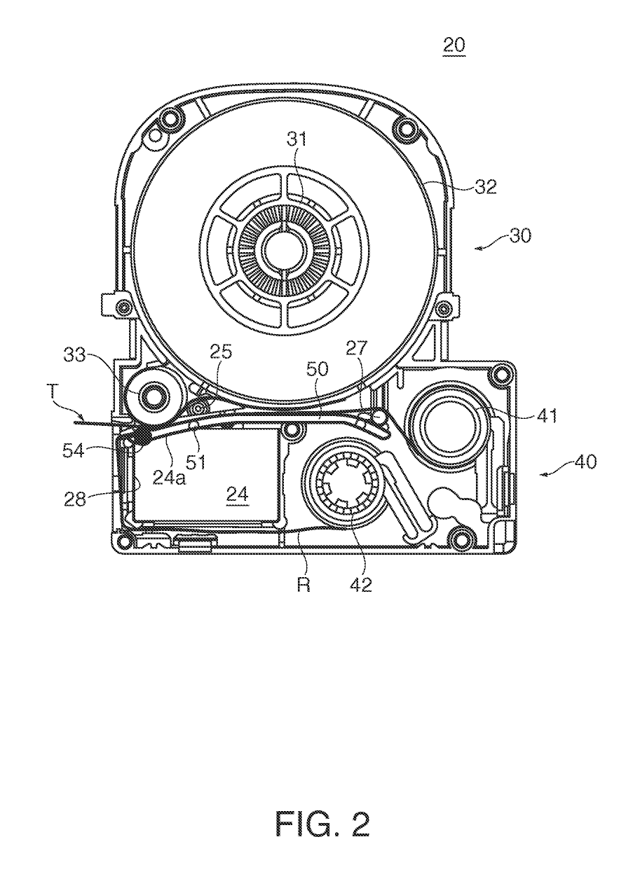

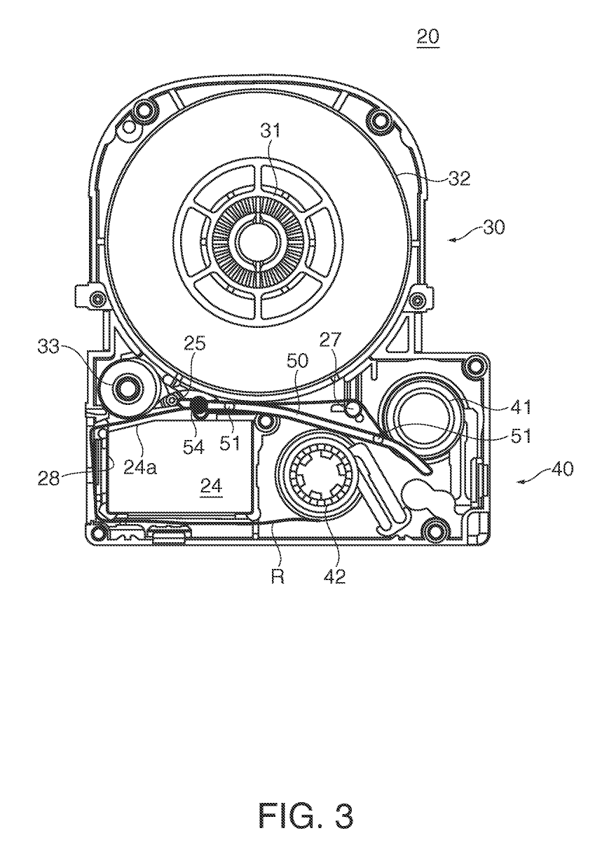

A thermal head 10 covered by a head cover 9, a platen drive shaft 11 disposed opposed to the thermal head 10 to feed the printing tape T, a winding drive shaft 12 for winding the ink ribbon R, and a positioning projection 13 for positioning a tape core 31 (see FIGS. 2 and 3) project from the cartridge attachment unit 5. Though not shown in the figures, a tape feeding mechanism constituted by a feed motor, a gear train and the like for rotating the platen drive shaft 11 and the winding drive shaft 12 in synchronization with each other is contained in the lower space below the bottom plate of the cartridge attachment unit 5.

When the open/close cover 4 is closed after attachment of the tape cartridge 20, the thermal head 10 comes into contact with a platen roller 33 (see FIG. 2) provided on the tape cartridge 20 with the printing tape T and the ink ribbon R sandwiched between the platen roller 33 and the thermal head 10 to come into a printing standby condition. When a printing command is issued by operating a predetermined key after input of characters or others through the keyboard 14 or the like, the printing tape T and the ink ribbon R are delivered by the tape feeding mechanism described above such that the tape T and the ribbon R can travel in synchronization with each other. Then, the printing process (thermal transfer of ink from the ink ribbon R to the printing tape T) is performed on the printing tape T.

A tape outlet port 15 for connecting the cartridge attachment unit 5 and the outside of the device is formed on the left side of the device case 3 such that the printing tape T after the printing process can be discharged through the tape outlet port 15. A cutter unit (not shown) driven by a cutter motor (not shown) is contained in the device case 3 at a position opposed to the tape outlet port 15. By this arrangement, the printed portion of the printing tape T delivered through the tape outlet port 15 can be cut along the tape width to be formed into a tape piece.

A power source supply port (not shown) for supplying power source, and a connector (not shown) for connecting to an external device such as a personal computer disposed in an area out of the figure are provided on the right side of the device case 3. The tape printer 1 having this structure can print not only printing images produced according to input data received from the keyboard 14 of the tape printer 1 but also printing images produced by using a personal computer or the like on the printing tape T. A circuit board constituting a controller for supervising and controlling the device main body 2 is mounted inside the device case 3 (not shown).

The structure of the tape cartridge 20 and an open/close mechanism of a shutter 50 in this embodiment are now explained chiefly with reference to FIGS. 2 and 3. FIG. 2 illustrates a concept of a closed condition of the shutter 50 of the tape cartridge 20 in this embodiment, and FIG. 3 illustrates a concept of an opened condition of the shutter 50 of the tape cartridge 20 in this embodiment. The tape cartridge 20 includes a cartridge case 23 (see FIG. 1) having an upper case 21 and a lower case 22. The cartridge case 23 contains a tape storing portion 30 for storing the printing tape T, and a ribbon storing portion 40 for storing the ink ribbon R, a drawing core 41 from which the ink ribbon R is drawn out, and a winding core 42 around which the ink ribbon R is wound.

The tape storing portion 30 contains a tape assembly 32 having the printing tape T and a tape core 31 around which the printing tape T is wound.

The ribbon storing portion 40 contains a ribbon assembly 43 having the ink ribbon R, the drawing core 41 from which the ink ribbon R is drawn out, and the winding core 42 around which the ink ribbon R is wound. The ribbon storing portion 40 further contains the hollow and cylindrical platen roller 33 disposed opposed to the thermal head 10. The tape core 31, the drawing core 41, the winding core 42, and the platen roller 33 are supported by shaft projections and engaging holes formed on the upper case 21 and the lower case 22 in such a manner as to be freely rotatable.

The cartridge case 23 has a through opening 24 disposed in the vicinity of the platen roller 33 and penetrating through the cartridge case 23 in the up-down direction. When the head cover 9 is inserted into the through opening 24 for attachment of the tape cartridge 20 to the cartridge attachment unit 5, the thermal head 10 within the head cover 9 comes opposed to the platen roller 33, and at the opposed position an opening 24a is provided. In this condition, engagements between the positioning projection 13 and the tape core 31, between the platen drive shaft 11 and the platen roller 33, and between the winding drive shaft 12 and the winding core 42 are achieved. That is, the platen roller 33 and the winding core 42 function as driving cores, and the tape core 31 and the drawing core 41 function as driven cores.

The printing tape T drawn from the tape core 31 is guided by a tape guide pin 25 to reach the platen roller 33, where the printing tape T is subjected to printing and delivered through a tape outlet port 26 formed on the side surface of the cartridge case 23. On the other hand, the ink ribbon R drawn from the drawing core 41 reaches the platen roller 33 while tensioned. In this case, the ink ribbon R is guided by a ribbon guide pin 27 and an opening wall 28 forming the through opening 24, and returned in the opposite direction to be wound around the winding core 42. According to this structure, the platen roller 33 and the winding core 42 on the driving side rotate in synchronization with each other, which allows the printing tape T and the ink ribbon R to synchronously travel and performs printing on the printing tape T.

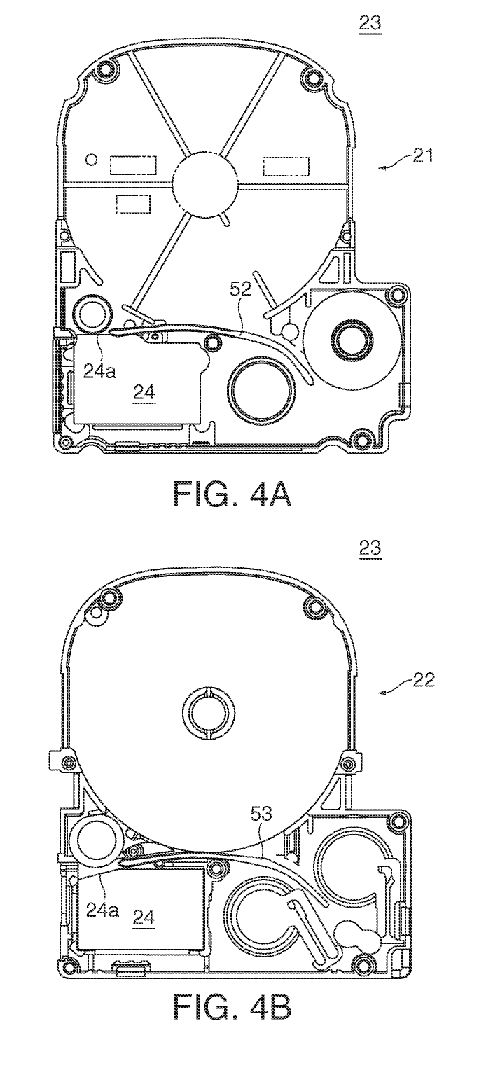

A shutter 50 capable of sliding is provided inside the ink ribbon passage between the ribbon guide pin 27 and the opening wall 28. The shutter 50 has slide projections 51 disposed at both ends of the shutter 50 in such positions as to engage with and slide on an upper case rail 52 provided on the upper case 21 and a lower case rail 53 provided on the lower case 22 (see FIGS. 4A and 4B). The shutter 50 further has an open/close projection 54. In response to operation of the open/close projection 54 by the user, the shutter 50 slides with the guide of the upper case rail 52 and the lower case rail 53 to perform the opening and closing operation of the shutter 50.

The tape cartridge 20 having this structure in this embodiment prevents exposure of the opening 24a of the through opening 24 penetrating through the cartridge case 23 in the up-down direction by closing the shutter 50. Thus, dust does not enter the inside of the tape cartridge 20 through the opening 24a at least except for the time of printing operation.

Moreover, dust does not enter through the opening 24a provided on the through opening 24 penetrating through the cartridge case 23 in the up-down direction for receiving the thermal head 10 when the shutter 50 is closed during transportation of the tape cartridge 20. Thus, the necessity for individually packing the tape cartridge 20 which has no shutter structure for transportation is eliminated. Accordingly, the tape cartridge 20 in this embodiment is more environment-friendly.

Furthermore, the thermal head 10 can be pressed against the ink ribbon R by opening the shutter 50 through the operation of the open/close projection 54 during the printing process. In this case, even while the tape cartridge 20 is attached to the tape printer 1, the printing tape T and the ink ribbon R are not sandwiched between the thermal head 10 and the platen roller 33 under the printing standby condition. Thus, dirt on the thermal head 10 produced by the ink ribbon R and deformation of the platen roller 33 caused by the constant press on the platen roller 33 by the thermal head 10 can be avoided.

The case rails for guiding the opening and closing operation of the shutter 50 according to this embodiment are now explained with reference to FIGS. 4A and 4B. FIG. 4A shows the upper case rail 52 provided on the upper case 21, and FIG. 4B shows the lower case rail 53 provided on the lower case 22. The upper case rail 52 and the lower case rail 53 extend from approximately the center between the drawing core 41 and the winding core 42 toward below the ribbon guide pin 27, and pass along the passage of the ink ribbon R to face to the opening 24a. The opening 24a is opened and closed in accordance with the sliding movement of the shutter 50 along the upper case rail 52 and the lower case rail 53.

According to this embodiment, the shutter 50 is arbitrarily opened and closed by the user through the operation of the open/close projection 54. However, the shutter 50 may be opened and closed in accordance with a series of printing operations, for example.

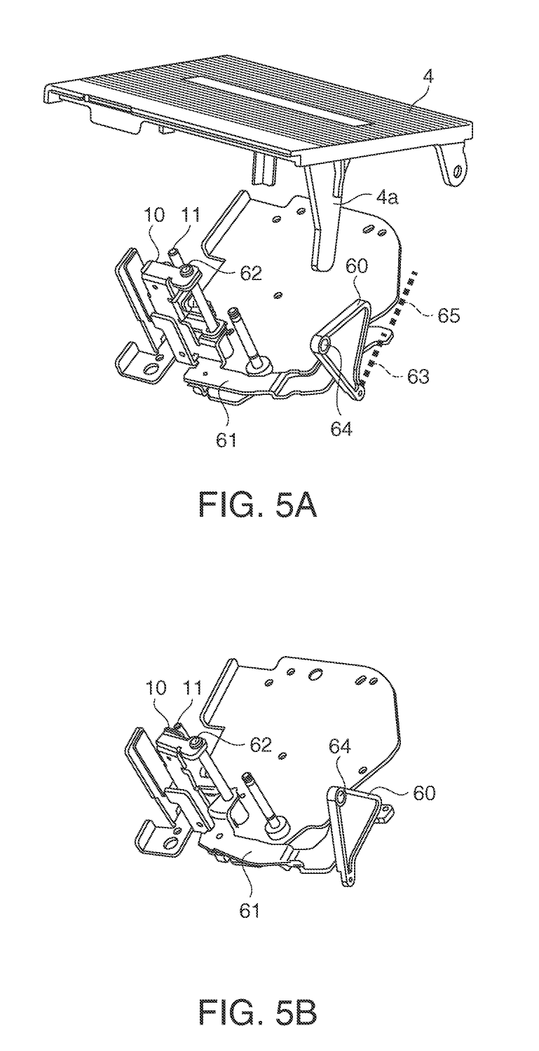

A shutter structure openable and closable by a series of printing operations according to a second embodiment of the invention is now described. FIGS. 5A and 5B illustrate a head release mechanism operating in accordance with the opening and closing of the open/close cover 4. The shutter structure according to the second embodiment of the invention opens and closes the shutter in accordance with the operation of the head release mechanism which is now explained with reference to FIGS. 5A and 5B. FIG. 5A illustrates a concept of the position of the thermal head 10 when the open/close cover 4 is opened, and FIG. 5B illustrates a concept of the position of the thermal head 10 when the open/close cover 4 is closed. FIG. 5B does not show the open/close cover 4 for easy understanding of the explanation. The thermal head 10 is attached to an end of a head rotational frame 61. The head rotational frame 61 is connected rotatably around a head rotational frame pin 62 as the rotation center. The other end of the head rotational frame 61 is connected with a head pressure spring 63 and a head release spring 65. The other end of the head pressure spring 63 is connected with a release lever 60, and the other end of the head release spring 65 is connected with the device case 3 or the cartridge attachment unit 5. The release lever 60 is connected with the device case 3 or the cartridge attachment unit 5 in such a manner as to be rotatable around a head release lever rotation center 64.

In performing the normal printing, the open/close cover 4 of the printer is opened, and the tape cartridge 20 is inserted. Then, what is desired to be printed is inputted after the open/close cover 4 is closed, and the printing operation is now initiated. An open/close cover projection 4a of the open/close cover 4 comes into contact with the release lever 60 in the closing condition of the open/close cover 4, and the release lever 60 is rotated around the head release lever rotation center 64. By the rotation of the release lever 60, the head pressure spring 63 is expanded. As a result, the head rotational frame 61 is rotated around the head rotational frame pin 62, and the thermal head 10 attached to the one end of the head rotational frame 61 is pressed against the platen roller 33 to come into the printing standby condition. On the other hand, at the time of opening the open/close cover 4, the thermal head 10 is separated from the platen roller 33 by the force of the head release spring 65 attached to the head rotational frame 61.

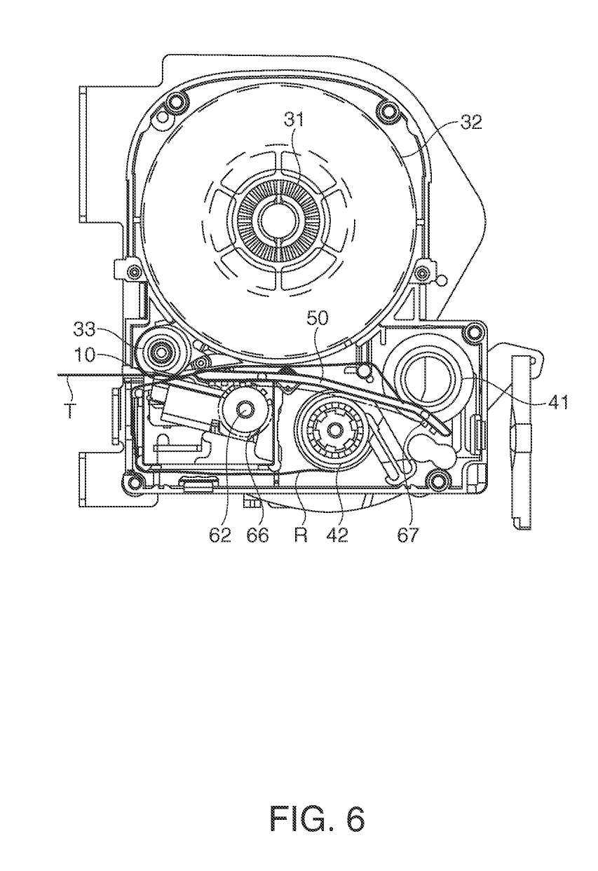

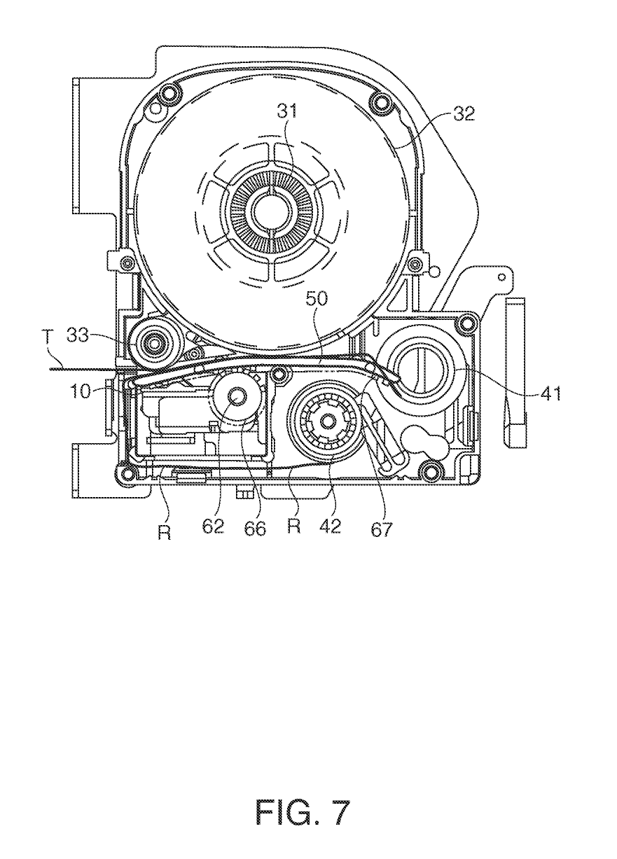

The shutter structure according to the second embodiment of the invention is now explained with reference to FIGS. 6 and 7. FIG. 6 illustrates a condition in which the shutter is opened in the second embodiment, and FIG. 7 illustrates a condition in which the shutter is closed in the second embodiment. As illustrated in FIG. 6, a shutter open/close gear 66 is provided at the rotation center of the head rotational frame pin 62. Moreover, a shutter open/close rack gear 67 is provided on the shutter 50 in such a manner as to engage with the shutter open/close gear 66.

According to this structure, when the open/close cover 4 is closed after attachment of the tape cartridge 20 to the cartridge attachment unit 5 of the tape printer 1, the open/close cover projection 4a of the open/close cover 4 comes into contact with the release lever 60. Then, the release lever 60 rotates around the head release lever rotation center 64. By the rotation of the release lever 60, the head pressure spring 63 is expanded, and the head rotational frame 61 is rotated around the head rational frame pin 62. By the rotation of the head rotational frame pin 62, the shutter open/close gear 66 rotates. Then, the shutter open/close rack gear 67 engaging with the shutter open/close gear 66 moves with the rotation of the shutter open/close gear 66 to open the shutter 50.

When the open/close cover 4 is opened, the head rotational frame pin 62 rotates in the opposite direction by the force of the head release spring 65 attached to the head rotational frame 61. As a result, the shutter open/close gear 66 rotates in the opposite direction. Then, the shutter open/close rack gear 67 engaging with the shutter open/close gear 66 moves with the rotation of the shutter open/close gear 66 to close the shutter 50. According to this structure, the shutter 50 can be opened and closed without recognition by the user. Moreover, the shutter 50 starts opening at the time when the shutter open/close gear 66 starts moving. Since the operation for initiating the movement of the shutter open/close gear 66 starts in the middle of the time of closing the open/close cover 4, the time of exposure of the opening 24a becomes shorter than in a structure which opens and closes the shutter 50 by the arbitrary operation of the user as shown in FIGS. 2 and 3. Accordingly, entrance of dust into the tape cartridge 20 can be more securely prevented.

It is intended that the invention is not limited to a structure which includes the positions and constructions of the respective parts of the tape cartridge 20 in the embodiments described herein and the structure is shown only as examples. For example, while the tape cartridge 20 attached to the tape printer 1 has been discussed as an example of the invention, the tape cartridge according to the invention may be of other types as long as they can store a tape used for recording within a cartridge case, such as a cassette tape, a video tape, and a DAT.

What is claimed is:

1. A tape cartridge attached to an attachment unit of a tape printer, comprising:
a cartridge case which has an upper case and a lower case,
wherein the cartridge case includes
a tape storing unit storing a printing tape on which printing is performed by using a thermal head provided on the tape printer,
a ribbon storing unit storing an ink ribbon used for printing on the printing tape by using the thermal head, and
an opening into which the thermal head is inserted, and
an openable and closable shutter structure is provided on the opening.

2. The tape cartridge according to claim 1, wherein the shutter structure executes an opening and closing operation by sliding on case rails provided on the upper case and the lower case of the cartridge case.

3. The tape cartridge according to claim 1, wherein:
the shutter structure further includes an open/close projection; and
the shutter structure executes the opening and closing operation by moving the open/close projection.

4. The tape cartridge according to claim 1, wherein the opening and closing operation of the shutter structure opens the opening at least during printing and keeps closing the opening except for the time of printing.

5. The tape cartridge according to claim 1, wherein the shutter structure executes the opening and closing operation in accordance with a head release mechanism included in the tape printer.
